(19) United States
(12) Patent Application Publication
(10) Pub. No.: US 2022/0053804 A1
(43) Pub. Date: Feb. 24, 2022

(54) METHOD FOR MANUFACTURING A PROTEO-OLEAGINOUS-BASED FERMENTED FOOD PRODUCT

(71) Applicant: LES NOUVEAUX AFFINEURS, Massy (FR)

(72) Inventor: Nour AKBARALY, Vanves (FR)

(21) Appl. No.: 17/415,827

(22) PCT Filed: Dec. 23, 2019
(86) PCT No.: PCT/FR2019/000216

§ 371 Date: Jun. 18, 2021

(30) Foreign Application Priority Data
Dec. 21, 2018 (FR) FR1873928

(51) Int. Cl. A23L 11/50; A23L 29/00

(52) U.S. Cl. CPC A23L 11/50; A23L 29/015

(57) ABSTRACT

The present invention relates to a method for manufacturing a proteo-oleaginous-based fermented food product and the product obtained by said method. The product is characterized by an origin that may be 100% plant-based and, in particular, without any dairy or animal products and, therefore, particularly suitable for people who follow a vegetarian or lactose-free diet. The method comprises steps of grinding, coagulation, fermentation, salting, and refining a proteo-oleaginous product.

The present invention relates to a method for manufacturing a proteo-oleaginous-based fermented food product, and the product obtained by said method. Said product is characterized by an origin which may be 100% plant-based origin, and in particular without dairy or animal products and thus particularly suitable for persons following a lactose-free or vegetarian diet. The method comprises steps of grinding, coagulation, fermentation, salting, and maturing of a proteo-oleaginous product.

In the field of the food industry, the increase, in recent years, of food intolerances, in particular to lactose and to gluten, as well as dietary habits without foods of animal origin, such as diets referred to as vegetarian or “vegan,” have caused an explosion in the demand for processed foods which guarantee, to these consumers, an absence of these undesired ingredients, but have good organoleptic qualities which are as close as possible to conventional food products containing these undesired ingredients.

With this in mind, a number of manufacturers have attempted to obtain fermented food products based on ingredients of plant-based origin. Vegetable juice has been used in the food industry for a number of years. Significant progress was made in the 1990s, following the development of a method for fermentation of vegetable milk, described in particular in the patent EP-A-0.521.331. Indeed, said patent relates to a method for fermentation of soya milk, using an inoculum based on at least two specific strains of Lactococcus resulting in products having a yogurt-type texture. However, products of this kind cannot be used as a substitute for a dairy product.

Another patent i.e. the patent GB-A-1.356.363, in turn describes a method for manufacturing food products resulting from the lactic fermentation of soya milk in which it is necessary, after fermentation, to implement a step of heating the product obtained. However, said products do not have the desired organoleptic qualities and have an undesired vegetable odor and taste.

An aim of the present invention is therefore that of proposing a method for manufacturing a novel fermented food product of entirely plant-based origin, the organoleptic characteristics of which render the products comparable to traditional fermented dairy products obtained from milk of animal origin.

The applicant has identified a plant-based source that is of interest for the production of a product of this kind, the proteo-oleaginous products, and in particular the association of soya and cashew, and has developed a novel production method which makes it possible to obtain a fermented food product of entirely plant-based origin having the desired organoleptic characteristics.

The invention:

The present invention firstly relates to a method for manufacturing a proteo-oleaginous-based fermented food product, characterized in that it comprises the successive steps of:

a. preparation of an initial product by grinding and/or homogenization of at least one proteo-oleaginous product with water;

b. optionally, a step of coagulation of said initial product obtained in step a.;

c. molding the product obtained in step a. or b.;

d. fermentation of the product obtained in step c., at a temperature of between 10 and 40° C. for a period of 5 to 48 hours;

e. demolding the product obtained in step d.;

f. salting the product obtained in step e.;

g. applying ferments to the outside of the product obtained in step f.;

h. maturing the product obtained in step g., at a temperature of between 4 and 20° C. and at a relative humidity of between 70 and 100%, for a period of at least 4 hours;

it being possible for the combination of the successive steps f., g., and h. to be repeated one or more times in order to obtain a final product.

According to the invention, proteo-oleaginous product means an oleaginous or proteo-oleaginous plant, in particular the seeds or the fruits of said oleaginous or proteo-oleaginous plant. In a general manner, said seeds or fruits are rich in lipids and/or rich in proteins.

Preferably, according to the present invention, said method according to the present invention is characterized in that said at least one proteo-oleaginous product is selected from cashew nut, macadamia nut, Brazil nut, hazelnut, almond, walnut, or another member of the nut family, pea, soya, lupin, chickpea, lentils, or another member of the legume family, flax, and/or sunflower.

The method according to the present invention is characterized in that said at least one proteo-oleaginous product is whole, pureed, and/or in milk form.

According to the present invention, soya preferably means dehulled soya or in the form of soya milk (tonyu) having a dehulled soya concentration similar to that in the case of dehulled soya not originating from tonyu. This primary material is prepared by means of traditional techniques that are part of the general knowledge of a person skilled in the art, from dehulled soya beans and water, and then optionally pasteurized and/or sterilized. Soya milk means, in an equivalent manner, soya juice.

According to the present invention, cashew preferably means shelled cashew nuts (which can also be referred to as cashew kernels), either whole or in pieces.

Preferably, according to the present invention, said at least one proteo-oleaginous product is a combination of soya, preferably in the form of soya juice, and cashew preferably in the form of shelled cashew nuts, either whole, or in pieces, or cashew juice.

Preferably, according to the present invention, said initial product is prepared from 0.25 to 90 wt. % cashew, preferably between 9 and 50 wt. % cashew.

Preferably, according to the present invention, said initial product is prepared from 0.25 to 50 wt. % soya, preferably between 2 and 20 wt. % soya.

Preferably, according to the present invention, said initial product is prepared from 0.25 to 90 wt. % cashew and from 0.25 to 50 wt. % soya.

Preferably, according to the present invention, said initial product is prepared from 2 to 70 wt. % cashew and from 1 to 30 wt. % soya.

Preferably, according to the present invention, said initial product is prepared from 9 to 50 wt. % cashew and from 2 to 20 wt. % soya.

According to an embodiment of the invention, said initial product is prepared from 50 to 90 wt. % cashew nut, preferably from 60 to 90%.

Preferably, according to the present invention, said method according to the present invention is characterized in that said step a. comprises grinding of the initial product at a speed of from 1,000 to 40,000 rpm for 30 to 360 seconds.

According to the present invention, grinding means dividing solid elements.

Preferably, according to the present invention, the optional step b. of coagulation is performed by means of bacterial coagulation, by enzymatic coagulation, or by heating.

According to an embodiment, the coagulation by means of heating of the initial product, preferably previously kept chilled following step a., is carried out at a temperature of between 50 and 90° C., preferably between 60 and 75° C., until a core temperature of between 50 and 85° C. is reached, preferably between 60 and 75° C. at the core of said product, even more preferably between 65° and 75° C.

Preferably, according to the invention, the product thus obtained is then chilled, until a temperature of between 15 and 35° C. is reached, for example at ambient temperature or in the refrigerator.

Preferably, according to the invention, the coagulation by means of heating may involve the addition of chemical coagulants.

Preferably, according to the present invention, the chemical coagulants are in the form of salt selected from magnesium chloride, calcium chloride, or calcium sulfate.

Preferably, according to the present invention, the calcium and/or magnesium salts are water-soluble salts and represent 0.01 to 1 wt. % with respect to the total amount of initial product obtained in step a., and required for production of the final proteo-oleaginous-based fermented food product.

Preferably, according to the invention, during heating, when a core temperature of between 50 and 85° C., preferably of between 60° and 75° C., even more preferably of between 65° and 75° C. at the core of said product, is reached, salts of magnesium chloride, calcium chloride, or calcium sulfate are added.

Preferably, according to the invention, after said chemical coagulants are added, the product thus obtained is then chilled, until a temperature of between 15 and 35° C. is reached, for example at ambient temperature or in the refrigerator.

According to an embodiment of the present invention, the enzymatic coagulation is achieved by adding non-animal enzymes—transglutaminase, pepsin, rennet, chymosin, and/or papain. A combination of these enzymes may be used within the scope of the coagulation step according to the present invention.

Preferably, according to the present invention, the enzymes transglutaminase, pepsin, rennet, chymosin, and/or papain are added in amounts representing from 0.01 to 1 wt. % with respect to the total amount of initial product obtained in step a., and required for production of the final proteo-oleaginous-based fermented food product.

According to an embodiment, said method according to the present invention is characterized in that the bacterial coagulation is achieved by adding lactic acid bacteria.

According to the present invention, lactic acid bacteria used for bacterial coagulation are preferably intended to mean the bacteria Brevibacterium linens, Candida valida, Corynebacterium flavescens, Hafnia alvei, Kluyveromyces lactis, Lactobacillus acidophilus, Lactobacillus bulgaricus, Lactobacillus paracasei, Lactobacillus plantarum, Lactobacillus rhamnosus, Lactococcus cremoris, Lactococcus diacetylactis, Lactococcus lactis, Leuconostoc cremoris, Candida yeast, Staphylococcus carnosus, Staphylococcus Xylosus, and/or Streptococcus thermophilus.

Preferably, according to the present invention, the lactic acid bacteria represent from 0.01 to 2 wt. %, preferably from 0.01 to 1 wt. %, with respect to the total amount of initial product obtained in step a., and required for production of the final proteo-oleaginous-based fermented food product.

Preferably, according to the present invention, said method according to the present invention is characterized in that the molding step is achieved using a product obtained in step a. (or b. in the case of step b. being carried out) at a temperature of between approximately 20° C. and approximately 30° C., preferably between approximately 25° C. and 30° C. The molding is preferably carried out using a measuring tool such as a ladle, a piping bag, or a piston funnel, or a dosing machine, by withdrawing the product obtained in step a. (or b. in the case of step b. being carried out), and placing it into a mold or muslin.

Preferably, according to the present invention, said method according to the present invention is characterized in that the fermentation in step d. involves addition of at least one dough ferment and/or at least one maturation ferment.

Preferably, according to the present invention, said method according to the present invention is characterized in that said at least one dough ferment is selected from Brevibacterium linens, Candida valida, Corynebacterium flavescens, Hafnia alvei, Kluyveromyces lactis, Lactobacillus acidophilus, Lactobacillus bulgaricus, Lactobacillus paracasei, Lactobacillus plantarum, Lactobacillus rhamnosus, Lactococcus cremoris, Lactococcus diacetylactis, Lactococcus lactis, Leuconostoc cremoris, Candida yeast, Staphylococcus carnosus, Staphylococcus Xylosus, and/or Streptococcus thermophilus.

Preferably, according to the present invention, said dough ferment is added in amounts representing from 0.01 to 2 wt. %, preferably from 0.01 to 1 wt. %, with respect to the total amount of initial product obtained in step a., and required for production of the final proteo-oleaginous-based fermented food product.

Preferably, according to the present invention, said method according to the present invention is characterized in that said at least one maturation ferment is selected from Brevibacterium casei, Brevibacterium linens, Candida colliculose, Debaryomyces hanseii, Geotrichum candidum, Kluyveromyces marxianus, Penicillium candidum, Penicillium commune, Penicillium nalgiovensis, Penicillum Roqueforti, Trichosporon.

Preferably, according to the present invention, said maturation ferment is added in amounts representing from 0.01 to 2 wt. %, preferably from 0.01 to 1 wt. %, with respect to the total amount of initial product obtained in step a., and required for production of the final proteo-oleaginous-based fermented food product.

Preferably, according to the present invention, the demolding step is carried out at ambient temperature.

The step f. of salting the product is preferably carried out using dry salt (NaCl) or brine, according to traditional salting methods that are part of the general knowledge of a person skilled in the art.

Preferably, according to the invention, step f. is carried out by powdering, with dry salt, of from 0.5 to 2 wt. % of the product obtained in step e.

Preferably, the salting step is carried out using brine.

Even more preferably, the product is plunged into brine containing between 5 and 35% salt, for between 1 and 30 minutes.

Preferably, according to the present invention, said method according to the present invention is characterized in that step g. is carried out by applying at least one maturation ferment to the surface of the product.

Preferably, according to the present invention, said method according to the present invention is characterized in that said at least one maturation ferment is selected from Brevibacterium casei, Brevibacterium linens, Candida colliculose, Debaryomyces hanseii, Geotrichum candidum, Kluyveromyces marxianus, Penicillium candidum, Penicillium commune, Penicillium nalgiovensis, Penicillum Roqueforti, Trichosporon.

The present invention secondly relates to a proteo-oleaginous-based fermented food product, characterized in that it is obtained by the method according to the present invention.

Preferably, according to the present invention, the proteo-oleaginous base of said fermented food product is the combination of soya and cashew alone.

Preferably, according to the present invention, said fermented food product is 75%, preferably 95%, preferably 99%, preferably 100%, of plant-based origin. In particular, said product does not contain any trace of animal product, in particular dairy product. Preferably, according to the present invention, said fermented food product does not contain lactose.

Preferably, according to the present invention, said fermented food product does not contain gluten.

Preferably, according to the present invention, said fermented food product is present in the form of gel, puree, rounds, portions, slices, mini-rounds, or in grated form.

Said products exhibit qualitative and organoleptic characteristics (texture, natural flavor, taste) that are very close to those of traditional fermented dairy products.

At the end of the production, said food product according to the present invention is packaged and stored at 4° C. until sale, having a shelf life of from several days to several weeks.

The examples below illustrate the products obtained according to the present invention:

### Example 1: Preparation of a Batch of 12 Products Based on Cashew and Soya

810 g of cashew and 360 g of soya are ground in 630 g water to obtain a homogeneous mixture.

Said obtained mixture is then heated at 80° C. for 1 hour.

The product obtained is then divided into 12 molds.

Said molded products are then fermented at a temperature of 30° C. for a period of 12 hours, using the following ferments:

i. Dough ferments:

Brevibacterium linens, Candida valida, Corynebacterium flavescens, Kluyveromyces lactis, Lactobacillus acidophilus, Lactobacillus bulgaricus, Lactobacillus paracasei,;

ii. Maturation ferments:

Debaryomyces hanseii, Geotrichum candidum, Kluyveromyces marxianus, Penicillium candidum, Brevibacterium linens

The products obtained are then demolded, and powdered with 0.75 g dry salt on the surface of each product.

Following this salting, maturation ferments are applied to the outside of the products obtained in the preceding step:

i. Maturation ferments:

Debaryomyces hanseii, Geotrichum candidum, Kluyveromyces marxianus, Penicillium candidum, Brevibacterium linens

The products obtained are then matured at a temperature of 6° C. and a relative humidity of 99% for a period of 480 hours;

### Example 2: Preparation of a Batch of 12 Products of 150 g, Based on Cashew

1170 g of cashew is ground in 630 g water to obtain a homogeneous mixture.

The product obtained in the preceding step is then divided into 12 molds.

Said molded products are then fermented at a temperature of 20° C. for a period of 5 hours, using the following ferments:

i. Dough ferments:

Brevibacterium linens, Lactobacillus acidophilus, Lactobacillus bulgaricus, Lactobacillus paracasei,;

ii. Maturation ferments:

Debaryomyces hanseii, Geotrichum candidum, Kluyveromyces marxianus, Penicillium candidum, Trichosporon

The products obtained are then demolded, and salted using brine in a salt water solution having 20% NaCl concentration, for 10 minutes;

Following this salting, maturation ferments are applied to the outside of the products obtained in the preceding step:

i. Maturation ferments:

Debaryomyces hanseii, Geotrichum candidum, Kluyveromyces marxianus, Penicillium candidum, Trichosporon

The products obtained are then matured at a temperature of 18° C. and a relative humidity of 80% for a period of 240 hours;

### Example 3: Preparation of a Batch of 12 Products of 150 g, Based on Cashew

1620 g of cashew is ground in 180 g water to obtain a homogeneous mixture.

The product obtained in the preceding step is then divided into 12 molds.

Said molded products are then fermented at a temperature of 12° C. for a period of 48 hours, using the following ferments:

i. Dough ferments:

Lactobacillus acidophilus, Lactobacillus bulgaricus, Brevibacterium linens, Staphylococcus xylosus;

ii. Maturation ferments:

Debaryomyces hanseii, Geotrichum candidum, penicillium nalgiovensis, Trichosporon

The products obtained are then demolded, and powdered with 3 g dry salt on the surface of each product.

Following this salting, maturation ferments are applied to the outside of the products obtained in the preceding step:

i. Maturation ferments:

Lactobacillus acidophilus, Lactobacillus bulgaricus, Brevibacterium linens, Staphylococcus xylosus;

The products obtained are then matured at a temperature of 12° C. and a relative humidity of 90% for a period of 120 hours.

1. Method for manufacturing a proteo-oleaginous-based fermented food product, characterized in that it comprises the successive steps of:
a. preparation of an initial product by grinding and/or homogenization of at least one proteo-oleaginous product with water;
b. optionally, a step of coagulation of said initial product obtained in step a.;
c. molding the product obtained in step a. or b.;
d. fermentation of the product obtained in step c., at a temperature of between 10 and 40° C. for a period of 5 to 48 hours;
e. demolding the product obtained in step d.;
f. salting the product obtained in step e.;
g. applying ferments to the outside of the product obtained in step f.;
h. maturing the product obtained in step g., at a temperature of between 4 and 20° C. and at a relative humidity of between 70 and 100%, for a period of at least 4 hours;
it being possible for the combination of the successive steps f., g., and h. to be repeated one or more times in order to obtain a final product.

2. Method according to claim 1, characterized in that said at least one proteo-oleaginous product is selected from cashew nut, macadamia nut, Brazil nut, hazelnut, almond, walnut, or another member of the nut family, pea, soya, lupin, chickpea, lentils, or another member of the legume family, flax, and/or sunflower.

3. Method according to claim 2, characterized in that said at least one proteo-oleaginous product is a combination of soya, preferably in the form of soya juice, and cashew preferably in the form of shelled cashew nuts, either whole, or in pieces, or cashew juice.

4. Method according to claim 1, characterized in that said at least one proteo-oleaginous product is whole, pureed, and/or in milk form.

5. Method according to claim 1, characterized in that step b. of coagulation is performed by means of bacterial coagulation, by enzymatic coagulation, or by heating.

6. Method according to claim 1, characterized in that the coagulation by means of heating is carried out at a temperature of between 50 and 90° C., preferably between 60 and 75° C., until a core temperature of between 50 and 85° C. is reached, preferably between 60 and 75° C. at the core of said product, even more preferably between 65° and 75° C.

7. Method according to claim 5, characterized in that the coagulation by means of heating may involve the addition of chemical coagulants.

8. Method according to claim 7, characterized in that the chemical coagulants are in the form of salt selected from magnesium chloride, calcium chloride, or calcium sulfate.

9. Method according to claim 1, characterized in that the fermentation in step d. involves addition of at least one dough ferment and/or at least one maturation ferment.

10. Method according to claim 9, characterized in that said at least one dough ferment is selected from Brevibacterium linens, Candida valida, Corynebacterium flavescens, Hafnia alvei, Kluyveromyces lactis, Lactobacillus acidophilus, Lactobacillus bulgaricus, Lactobacillus paracasei, Lactobacillus plantarum, Lactobacillus rhamnosus, Lactococcus cremoris, Lactococcus diacetylactis, Lactococcus lactis, Leuconostoc cremoris, Candida yeast, Staphylococcus carnosus, Staphylococcus Xylosus, and/or Streptococcus thermophilus.

11. Method according to claim 9, characterized in that said at least one maturation ferment is selected from Brevibacterium casei, Brevibacterium linens, Candida colliculose, Debaryomyces hanseii, Geotrichum candidum, Kluyveromyces marxianus, Penicillium candidum, Penicillium commune, Penicillium nalgiovensis, Penicillum Roqueforti, Trichosporon.

12. Method according to claim 1, characterized in that step g. is carried out by applying at least one maturation ferment to the surface of the product.

13. Proteo-oleaginous-based fermented food product, characterized in that it is obtained by the method according to claim 1.
